(19) United States
(12) Patent Application Publication
(10) Pub. No.: US 2025/0129234 A1
(43) Pub. Date: Apr. 24, 2025

(54) PAINT COMPOSITIONS AND PAINT COATINGS FOR RADIATIVE COOLING AND RELATED METHOD OF MANUFACTURE

(71) Applicant: Purdue Research Foundation, West Lafayette, IN (US)

(72) Inventors: Xiulin Ruan, West Lafayette, IN (US); George Chiu, West Lafayette, IN (US); Andrea Felicelli, West Lafayette, IN (US); Ioanna Katsamba, West Lafayette, IN (US)

(21) Appl. No.: 18/687,391

(22) PCT Filed: Aug. 24, 2022
(86) PCT No.: PCT/US2022/041329

§ 371 Date: Feb. 28, 2024

Related U.S. Application Data
(60) Provisional application No. 63/238,124, filed on Aug. 28, 2021.

(51) Int. Cl. C08K 3/38; C09D 5/33; C09D 7/20; C09D 7/40; C09D 7/61; C09D 7/80; C09D 133/12

(52) U.S. Cl. CPC C08K 3/38; C09D 5/004; C09D 7/20; C09D 7/61; C09D 7/66; C09D 7/70; C09D 7/80; C09D 133/12; C08K 2003/385; C08K 2201/003; C08K 2201/011

(57) ABSTRACT

Paint compositions and paint coatings for radiative cooling, as well as related methods of manufacturing and use of such paint compositions. A composition for paint to be used in radiative cooling, in a wet coating phase, includes nanoplatelets of hexagonal boron nitride, an acrylic binder, and a solvent. A coating of a dried paint on a surface to be cooled by radiative cooling includes nanoplatelets of hexagonal boron nitride and an acrylic binder. A method of manufacturing the composition for paint in the wet paint phase includes forming a first mixture by adding the nanoplatelets of hexagonal boron nitride to the solvent, uniformly distributing the nanoplatelets in the first mixture, and forming a second mixture by adding the acrylic binder to the first mixture.

### CROSS-REFERENCE TO RELATED APPLICATIONS

This application claims the benefit of U.S. Provisional Application No. 63/238,124, filed Aug. 28, 2021, the contents of which are incorporated herein by reference.

### STATEMENT REGARDING FEDERALLY SPONSORED RESEARCH

This invention was made with government support under DMR 2102645 awarded by the National Science Foundation. The government has certain rights in the invention.

### BACKGROUND OF THE INVENTION

The invention relates generally to paint compositions and paint coatings for radiative cooling, as well as related methods of manufacturing and use of such paint compositions.

According to the United States Department of Energy, 6% of the average household's energy use goes towards space cooling. This is due to cooling technologies that rely on electricity generated via processes with high carbon emissions. At a time when many are interested in working to address climate crises affecting Earth, it is important to look into ways to reduce carbon-footprint in everyday life.

Radiative cooling is a passive and environmentally friendly cooling technology that allows for effective dissipation of heat directly into deep space, hence it not only consumes no power, but also combats global warming and urban heat island effect. Radiative cooling works due to the temperature differential between a surface on earth and the extremely cold deep space, allowing for an exchange of energy to occur. Radiative cooling accomplishes this by reflecting solar irradiation and emitting thermal radiation via an atmospheric transparent window (thermal radiation with a wavelength range of 8-13 micrometers where the atmosphere is transparent, also called a sky window) into deep space, therefore not relying on electricity generation. Thus, a radiative cooling surface counteracts incoming solar irradiation with a surface that reflects light in the corresponding wavelengths of the solar spectrum back into space. In addition, the natural thermal radiation emissivity of surface materials contributes to the cooling effect by emitting thermal radiation in the sky window into space. When a material emits more heat in the sky window than it absorbs from the solar irradiation, the resulting net cooling power allows for cooling the surface on earth to a temperature below the surrounding ambient. As a contrast, conventional air conditioning removes heat from buildings and transfers it into the surrounding ambient air, so heat still stays in the city and on the earth. Radiative cooling, on the other hand, directly loses heat to the deep space, thereby, for example, reducing the heat island effect and/or cooling down the earth.

Radiative cooling coating and composite technologies have greatly advanced throughout the years. In one of the earliest studies on paints for radiative cooling, a thin commercial titanium oxide-based paint layer was coated on an aluminum plate to achieve daytime radiative cooling. However, the high solar reflectance was mostly from the metal substrate and not the paint itself, i.e., no substrate-independence was demonstrated. Another study measured the radiative cooling performance of several commercially available white paints. There have also been heat reflecting paints developed reaching 91% reflectance. These early studies on paints showed the need for improved solar reflectance in paints in order to reach full daytime cooling.

Other approaches to radiative cooling have involved non-paintable technologies. Outside of explicit radiative cooling considerations, sintered reflective ceramic coatings consisting of Al₂O₃, hexagonal Boron Nitride (hBN), and other particles were pursued for space applications and achieved spectral reflectance of 87.5%. 7. For example, full daytime radiative cooling has been achieved in photonic materials, such as integrated photonics solar reflectors and thermal emitters with several layers of silicon oxide and hafnium oxide, polymer coated, fused silica mirrors, resonant polar dielectric microspheres embedded in a polymer matrix with a metallic bilayer, structural materials consisting of delignified and densified wood, and pressed nanocomposite films embedded with hBN, with the latter achieving 98% solar reflectance at a rather thick film of 1.4 mm, as well as other photonic and multilayer structures. However, these approaches have one or more limitations, such as complicated multi-layered structures, a metallic layer, or a large thickness of more than 1 mm, to achieve the needed solar reflectance. Meanwhile, although radiative cooling films often have end components of particles and polymers, which are similar to that of paints, they are not paintable technologies, hence limiting their applications. In this scenario, and as used herein, radiative cooling film technologies and paint technologies should not be mixed, because a film technology usually cannot transit to a paint technology, or at least involves significant barriers yet to be resolved. Cooling paints, that is, a coating that is applicable in a substantially liquid form using standard brush, roller, or spray-painting techniques, are desired to allow for ease of use and viable applications on non-flat surfaces, compared to films.

There have also been more recent approaches to coating-type technologies for radiative cooling. For example, a double-layer acrylic coating embedded with titanium dioxide and carbon black nanoparticles was predicted to achieve full-daytime cooling. In another example, silica microsphere media without a binder were tested to show partial daytime cooling, and paint-like porous polymeric coatings with 5.5 μm and 200 nm pore sizes were developed with full-daytime cooling. In a further example, a strategy of broad particle size distribution was proposed to enhance the solar reflectance than a single size. Recently, high concentration CaCO₃ and BaSO₄-based paints have been developed with high solar reflectance and sky window emittance, which can achieve full daytime radiative cooling capabilities. BaSO₄ has high band gaps of 7.27 eV that can eliminate the UV absorption, and the high concentration and broad particle size distribution enable broadband high solar reflectance. It has also been suggested that the average particle size should be in the neighborhood of the peak solar wavelength (500 nm), and these sizes are more effective in scattering the sunlight than particle or pore size that is either too small (<100 nm) or too large (>1 μm). While high performance and greater ease of use have been demonstrated with paint technologies like these, they required 300 μm thickness to reach 96% solar reflectance in the porous polymer coatings, and 400 μm thickness to reach the highest reported solar reflectance of 98.1% in BaSO₄ paint, the whitest paint reported to date. Other ultra-white paints may need mm thickness to reach optimal performance.

In contrast, typical commercial paint thickness is typically about 120 micrometers on vehicles and about 150-200 micrometers on buildings, and each coat by brush or roller adds 50-75 micrometers of paint when dried. The much larger thickness of current radiative cooling paints would mean five to eight coats and much more labor are needed to obtain the desired radiative cooling capacity. Moreover, the density of BaSO₄ (4.5 g/cm³) is higher than the commercial TiO₂ (4.23 g/cm³). Therefore, the best radiative cooling paints available up to now represent significantly higher thickness and weight than commercial paints currently in use, and perhaps too high for many important applications that are weight-sensitive, such as automobiles, wearables, aerospace, and space applications.

From this, it can be seen that there remains a need to develop high-performance radiative cooling paints that are significantly thinner and/or lighter. This is a very challenging task as it means the backscattering coefficient needs to be remarkably enhanced as compared to the state of the art.

### BRIEF SUMMARY OF THE INVENTION

According to one nonlimiting aspect, a composition for paint to be used in radiative cooling is provided. The composition in a wet coating phase includes nanoplatelets of hexagonal boron nitride, an acrylic binder, and a solvent.

According to another nonlimiting aspect, a coating of a dried paint on a surface to be cooled by radiative cooling is provided. The coating includes nanoplatelets of hexagonal boron nitride and an acrylic binder.

According to yet another nonlimiting aspect, a method of manufacturing the composition for paint in the wet paint phase is provided. The method includes forming a first mixture by adding the nanoplatelets of hexagonal boron nitride to the solvent, and uniformly distributing the nanoplatelets in the first mixture. A second mixture is formed by adding the acrylic binder to the first mixture.

In some arrangements, the compositions, coatings, and/or methods of the present disclosure are believed to provide a radiative cooling paint with the characteristic of affording thin coatings of the paint and low-weight while being efficient in radiative cooling not heretofore achieved by radiative cooling paints.

These and other aspects, arrangements, features, and/or technical effects will become apparent upon detailed inspection of the figures and the following description.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure are by way of example, and not to be construed as limiting.

FIG. 1A schematically illustrates a method of preparing a radiative cooling paint in accordance with some nonlimiting aspects of the invention and various characterizations of the resulting paint. FIG. 1B shows top and side view SEM images of hBN nanoplatelets of a radiative cooling paint produced by FIG. 1A. FIG. 1C shows particle diameter distribution of 50 particles demonstrated in a histogram. FIG. 1D shows SEM images of a hBN-acrylic nanocomposite coating 20, with a top-down view and a cross-section view.

FIGS. 2A through 2D show spectral characterization results for hBN-acrylic coatings of FIGS. 1A through 1D with different thicknesses with various substrates and simulation results in accordance with some nonlimiting aspects of the invention.

FIGS. 3A through 3H show results of simulations of optical properties of various particles and the total reflectance of nanocomposites.

FIGS. 4A through 4C show setup and results of field tests made in the course of developing some nonlimiting aspects of the present invention.

FIGS. 5A and 5B shows results of abrasion and viscosity testing for samples of 60% hBN-acrylic according to certain nonlimiting aspects of the present invention with a coating thickness of 150 micrometers on 1-mm aluminum sheet substrates.

FIGS. 6A through 6D show another radiative cooling coating according to some nonlimiting aspects of the invention and its SEM images.

FIGS. 7A through 7C show results of spectral characterization for the hBN-acrylic coatings of FIGS. 6A through 6D of different thicknesses and on various substrates.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Thin and lightweight radiative cooling paints are needed for many weight- and thickness-sensitive applications, but it is difficult to achieve high solar reflectance with a thin layer. The inventors disclose herein a composition for paint to be used in radiative cooling that, in a wet coating phase, includes nanoplatelets of hexagonal boron nitride, an acrylic binder, and a solvent. In addition, the inventors disclose here a coating of a dried paint that includes nanoplatelets of hexagonal boron nitride and an acrylic binder. The inventors had demonstrated that the resulting thin and light-weight hBN-Acrylic nanoporous paints have high solar reflectance and sky window emissivity, and full daytime subambient cooling. The hBN in a nanoplatelet form was chosen due to its appropriate band gap and unique morphology. The upper bound of the photon energy in the solar spectrum is 4.13 eV, hence the material band gap needs to be higher than 4.13 eV to eliminate solar absorption. However, as the band gap increases, the refractive index decreases which weakens scattering and reflection. Therefore, a band gap moderately higher than 4.13 eV is preferred. hBN has a band gap of 5.96 eV, which is above 4.13 eV but significantly lower than that of BaSO₄, resulting in a refractive index of 2.1-2.3 in the solar spectrum when BN planes are oriented parallel to the electric field (hereafter called “in-plane” orientation, or perpendicular to the incident wave) and 1.4-1.6 when BN planes are vertical to the electric field (or parallel to the incident wave). In contrast, the refractive index is only 1.66 for BaSO₄. In addition, simulations also show that the higher refractive index and nanoplatelet morphology for hBN yield an unusual combination of Mie scattering-like high scattering coefficient and Rayleigh scattering-like strong backscattering, both of which favor high solar reflectance.

In some nonlimiting embodiments of the invention, the compositions, paints, and methods of the present invention provide ultrawhite hBN-acrylic nanoporous paints incorporating hexagonal Boron Nitride (hBN) nanoplatelets of diameter in the ranges of 332±193 nm and thickness in the range of 45±3 nm, and achieves solar reflectance of 97.9% and sky window emissivity of 0.83. The thickness and weight of the dried paint layer are only 150 μm and 0.029 g/cm², respectively, representing significant reductions from previous best radiative cooling paints. The high refractive index and nanoplatelet morphology of hBN enable a unique combination of Mie scattering-like high scattering coefficient and Rayleigh scattering-like strong backscattering, and a porosity of 44.3% offers high refractive index contrast between hBN and air, all of which contributes to achieving high solar reflectance with such a thin coating. Field tests show full daytime cooling under direct sunlight, reaching 5-6° C. below ambient on average. The hBN-acrylic nanoporous paint demonstrated comparable cooling performance to recent best technologies, and the thinness and lightweight reduce barriers towards many practical applications. In this embodiment, the nanoplatelets used had a diameter in the range of 332±193 nm, which is a range where the average diameter is optimum to strongly scatter the solar spectrum, and the non-uniform diameter distribution enables efficient broadband scattering as compared to a single size. A high nanoplatelet loading of 60% volume concentration was used to maximize light scattering while maintaining the desirable mechanical properties of the polymer binder. (Hereinafter, the % volume concentration is used to mean the volume concentration among the solid phases in the wet paint phase, if not otherwise stated. After the paint was dried, for example, the layer develops a porosity of 0.443 and the volume concentrations of hBN, acrylic, and air in the dry state become 33.4%, 22.3%, and 44.3%, respectively.) With this concentration, 97.9% reflectance in the solar spectrum and a sky window emissivity of 0.83 was achieved from a dried paint layer with a thickness of only 150-micrometer and weight of only 0.029 g/cm². Outdoor testing showed an average of 5-6 degrees Celsius cooling below ambient on the sample's surface. The thickness and weight were significantly lower than previous records of radiative cooling paints, while maintaining a solar reflectance among the highest. The thickness was now reduced to the typical range of commercial paints, whose lighter weight is attractive for weight-sensitive applications, such as automobiles, wearables, aerospace and space applications. Furthermore, it has wear-resistance, viscosity, and water resistance consistent with that of industry standards at only a fraction of the layer thickness.

Some optional variations include the following nonlimiting examples. The nanoplatelets of hexagonal boron nitride may have a diameter between about 120 nm and about 3000 nm and a thickness between about 20 nm and about 1000 nm, and in some arrangements may have a diameter between about 130 nm and about 550 nm and a thickness between about 40 nm and about 50 nm. In the wet coating phase, the volume percentage of the nanoplatelets of hexagonal boron nitride may be in the range of 3.0-18.0%. In the dried paint, the volume percentage of the nanoplatelets of hexagonal boron nitride may be in the range of 30-90%. The acrylic binder may be an acrylic binding resin, such as Elvacite®. The acrylic binder may have a volume percent in the range of 2.0-7.7% in the wet coating phase. In the dried paint, the acrylic binder may have a volume percent in the range of 10-70%. The solvent may have a volume percent in the range of 80-90% in the wet coating phase. The solvent may be dimethylformamide (DMF). The coating of a dried paint may have a thickness in the range of 30-1500 micrometers, including for example a thickness in the range of 70-500 micrometers, such as a thickness of about 70 micrometers and/or about 150 micrometers, although larger and smaller thicknesses are also possible. At a thickness of about 150 micrometers, the coating of dried paint may have a total solar reflectance of at least about 97%, for example about 97.9% to about 98.1%, in the solar spectrum and a total sky window emissivity of about 0.83. At a thickness of about 70 micrometers, the coating of dried paint may have a total solar reflectance of at least 90%, for example about 90.9% to about 91.0%, and a total sky window emissivity of at least 0.7, for example about 0.78. Other optional variations are also possible in view of the present disclosure.

A nonlimiting example method of manufacturing the composition for paint in the wet paint phase includes forming a first mixture by adding the nanoplatelets of hexagonal boron nitride to the solvent, uniformly distributing the nanoplatelets in the first mixture, and forming a second mixture by adding the acrylic binder to the first mixture. The first mixture may be uniformly distributed, for example, by sonicating it. The second mixture may be sonicated to promote uniformity. In addition, forming the first mixture and/or forming the second mixture may include simultaneously stirring and heating the respective mixture.

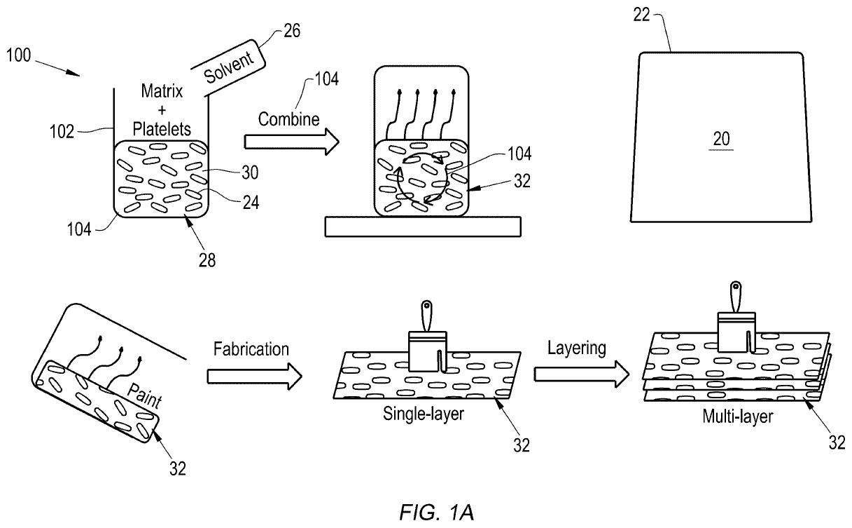

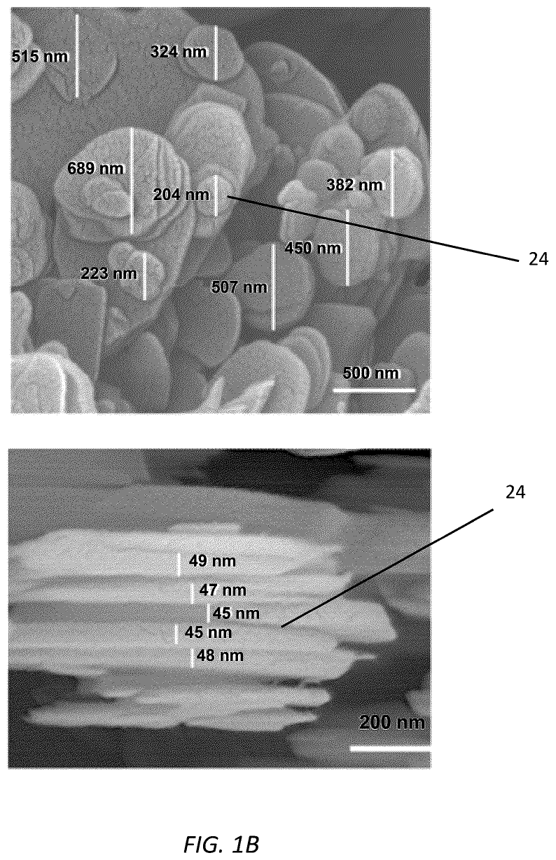

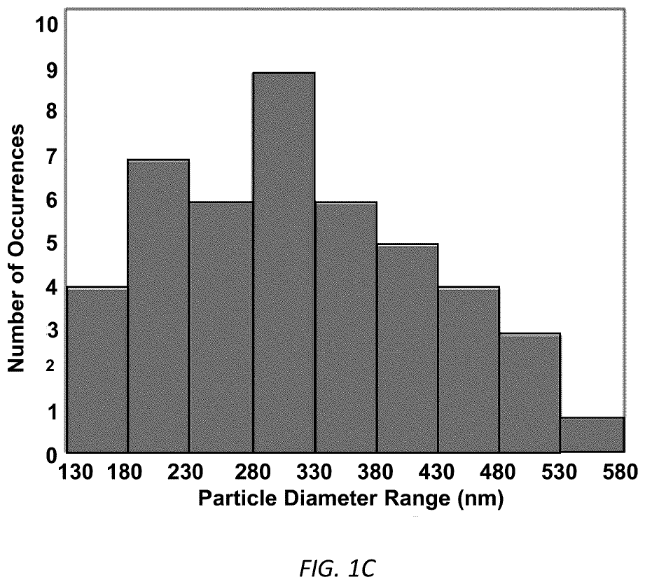

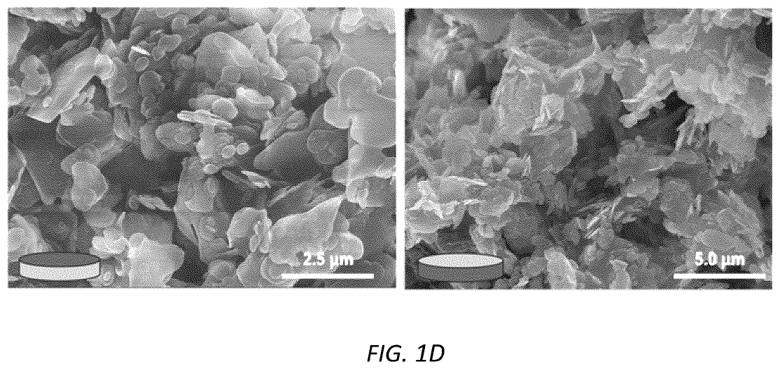

Turning now to the embodiments depicted in the drawings, FIGS. 1A through 1D schematically depict a method 100 of preparing the radiative cooling paint 20 and some characteristics thereof. In FIG. 1A illustrates a schematic of the method 100 of making the hBN-Acrylic paint 20 and an example image of a painted sample 22 with the dried layer of paint 20 tested throughout. FIG. 1B shows top and side view SEM images of the hBN nanoplatelets 24. The nanoplatelet diameter and thickness distributions were determined to be 332±193 nm and 45±3 nm, respectively. FIG. 1C shows particle diameter distribution of 50 particles demonstrated in a histogram, with the largest proportion of the diameters measured shown to be between 280-330 nm. FIG. 1D shows SEM images of the hBN-acrylic nanocomposite coating 20, with a top-down view and a cross-section view.

In the course of investigations, the inventors designed and fabricated hBN-Acrylic coatings with a range of different thicknesses. Since a high concentration is desirable to promote effective light scattering within the material, the paint was loaded with hBN nanoplatelets at hBN:Acrylic=60%:40% volume concentration. Samples were prepared by pouring or brushing uniform layers onto flat glass or aluminum substrates and allowed to fully dry in a fume hood. The resulting samples were visibly ultrawhite and opaque, with consistent layer thickness distributions across substrates. Again with reference to FIG. 1A, the method 100 of fabricating a sample of the hBN nanoplatelet-Acrylic paint was accomplished as follows. PCTP2 hBN nanoplatelets 24 were acquired from Saint Gobain Advanced Ceramics, LLC. At 102, the PCTP2 hBN nanoplatelets 24 were added in small quantities to DMF solvent 26 while stirring until all hBN was incorporated. The DMF solvent 26 was used to lower viscosity of the material. The mixture 28 was sonicated for 5 minutes to ensure uniform distribution of the nanoplatelets 24 in the solvent 26. An acrylic binder, in this case Elvacite® 2028 Acrylic powder from Lucite International, which was the chosen matrix material for its low viscosity, was then gradually added to the mixture 28 while stirring until dissolved fully. The overall solid-liquid ratio in the resulting second mixture 32 was 1:6. To help with the high viscosity of the material, the stir plate was used to heat it slightly to 30° C. At 104, this final mixture 32 was sonicated once again for 10 minutes to ensure uniformity. Samples of the final mixture 32, that is, the paint composition in its wet phase form, were poured in even layers onto 1 mm thick glass slides and 1-mm aluminum plates and left in a hood for a minimum of 6 hours to allow the DMF solvent 26 to fully evaporate, thereby forming a coating of dried radiative cooling paint 20 on the surface of the plates. The thickness of the samples 22 was measured at several locations using a caliper and/or profilometer. Although the acrylic binder used in the studies of this disclosure was Elvacite 2028 from Lucerin International, other polymer matrix materials could also be used in place of Acrylic, for example, latex or PDMS. Also, although DMF was employed as the solvent in the compositions described in this disclosure, other solvents, such as, but not limited to, isopropyl alcohol and toluene, can also be used.

SEM imaging was used to determine the nanoplatelet morphology, orientation, and observe their dispersion throughout the acrylic matrix of the paint composition. As seen in FIG. 1B, the nanoplatelet structure of the hBN 24 has a high aspect ratio (diameter to thickness) and directional properties, as well as a high degree of variability in diameter and low variability in thickness. FIG. 1C shows an overall diameter distribution of 332±193 nm, and FIG. 1B shows a fairly uniform distribution of platelet thickness of 45±3 nm, which is believed to contribute to improved light scattering and higher solar reflectance values as a result due to an average size in the neighborhood of the solar peak wavelength and a broad size distribution. The acrylic matrix that encapsulates and bonds the nanoplatelet filler 24 gives the material (paint 20) improved reliability under various conditions due to the polymer-filler composition similar to the majority of commercially-available paints, although with a higher pigment loading. In FIG. 1D, the platelets 24 can be observed to be in various orientations. Some horizontal orientation may be achieved due to the shear force effects of pouring techniques, where the paint was allowed to flow vertically downwards along the substrate due to gravitational effects, or brushing/screen-printing techniques, where the equipment distributes the paint directionally along the substrate surface. This orientation, with the surface of the platelet perpendicular to incident sunlight, allows the larger refractive index of the hBN 24 to take effect and enable efficient scattering. Although FIG. 1D shows that there remain some particles that can be observed to be at a more angled orientation, high radiative cooling performance was still achieved. This suggests that desired performance can be achieved without perfect particle alignment. The solvent 26, dimethylformamide (DMF), was added to the mixture at a 1:6 volume ratio, which was found to reduce viscosity associated with the high concentration of nanoplatelets to a usable level while maintaining low evaporation time of 2-4 hours depending on coating thickness. The average porosity of a dried paint layer 20 obtained from this composition was calculated to be 44.3% with a standard deviation of 1.4%. The pores in the dried paint layer can facilitate strong scattering and reduce the paint layer thickness needed, since they enable hBN-air interfaces with high refractive index contrast (nhBN:nₐᵢᵣ=2.3:1). (In contrast, porous polymers or fully dense hBN-PDMS photonic films without voids do not have such high contrast.) It is noted that the volume concentrations of hBN and acrylic in the composition were 60% and 40% among the solid phases in the wet paint state; however, after the paint was dried with a porosity of 0.443, the volume concentrations of hBN, acrylic, and air in the dried paint become 33.4%, 22.3%, and 44.3%, respectively.

Although the porosity can lead to soiling of the material over time in application, a hydrophobic, self-cleaning topcoat may be used to prevent or reduce this (if desired). The use of topcoats is a well-established technique and already very frequently used to address this issue for commercial paints in outdoor applications. Alternatively, or additionally, binders that show strong hydrophobic properties could also be used.

Details on the porosity calculations are as follows. The porosity of the final, dry material is calculated based on:

$$\% Porosity = ( 1 - \frac{Solid Sample Volume}{Total Sample Volume} ) * 100 \qquad ( Eq . 1 )$$

Three samples were measured to determine the sample mass and calculate the solid sample volume. The samples were made by pouring the paint to fully cover 50 mm×75 mm glass slide substrates with a consistent layer. The total sample volume for each sample was calculated by measuring the thickness of the poured layer once dry and multiplying by the area of the glass slide. The solid density was calculated using the known density of the acrylic binder, 1.185 g/cm³, and the hBN nanoplatelets, 2.1 g/cm³, as well as the known volume ratio of acrylic:hBN=4:6. Finally, the measured sample mass and solid density was used to calculate the solid sample volume after measuring the total mass of each sample and subtracting the mass of the glass slide substrate. Using these values, the average porosity of a dried paint layer of the present disclosure was calculated to be 44.3% with a standard deviation of 1.4%.

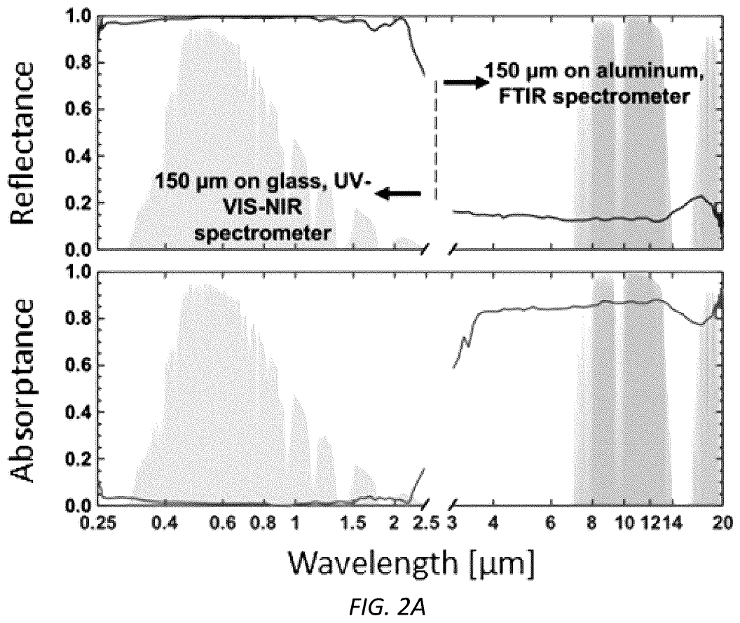

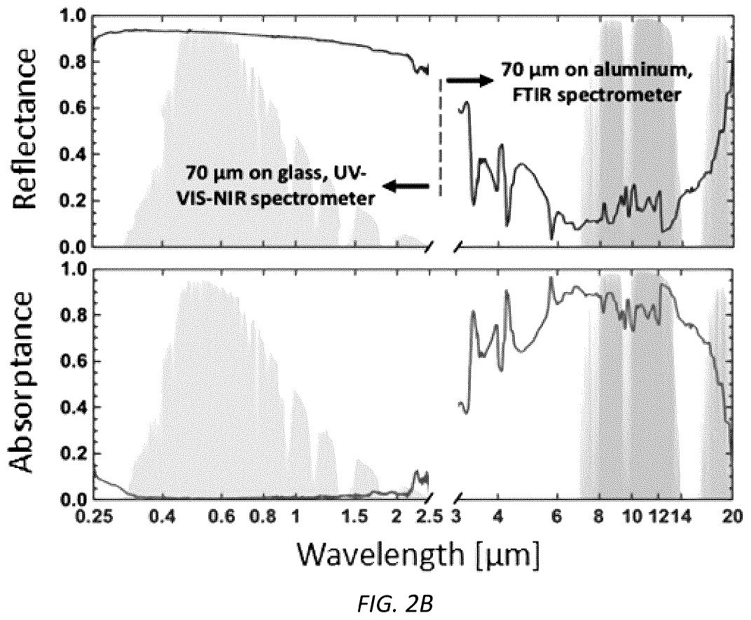

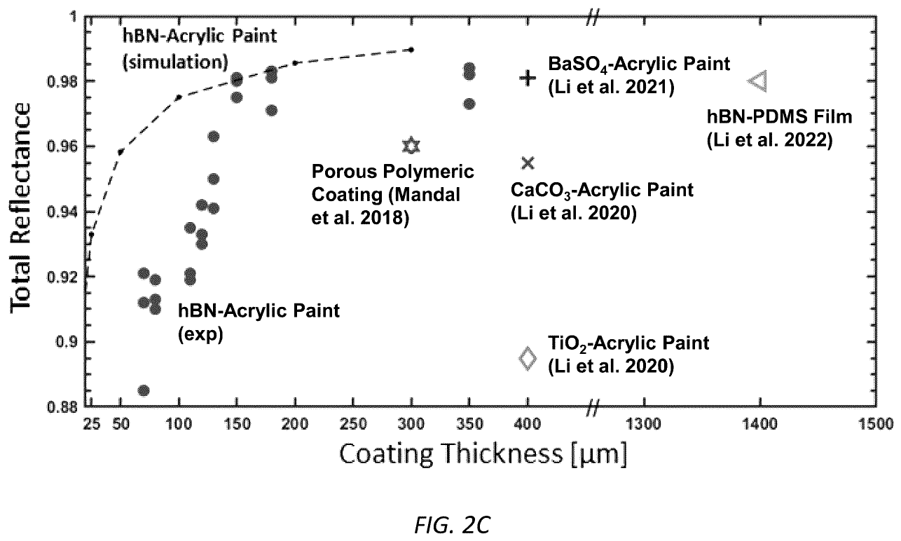

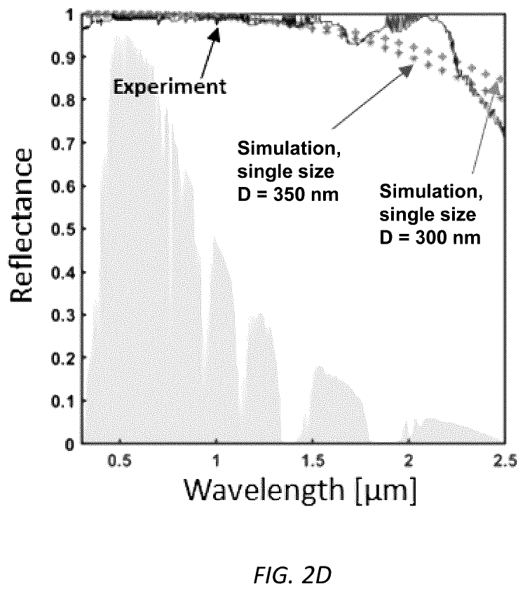

Turning to FIG. 2A shows spectral characterization of a 150-micrometer thick layer of hBN-Acrylic coating 20. The total solar reflectance was 97.9% and the total sky window emissivity was 0.83. Measurements from 0.25-2.5 micrometers were performed with a 1-mm thick glass substrate to avoid reflectance from the substrate, and measurements from 2.5-20 micrometers were performed with a 1-mm thick aluminum substrate to avoid emissivity contribution from the substrate. FIG. 2B shows spectral characterization of a 70-micrometer thick layer of the hBN-Acrylic coating 20. The total solar reflectance was 90.9% and the total sky window emissivity was 0.78. FIG. 2C shows the total solar reflectance as a function of the coating thicknesses. All hBN-Acrylic paint samples (red dots) were measured on 1 mm thick glass substrates. The simulated total reflectance (dashed line) as a function of the nanocomposite's thickness was calculated via Monte Carlo method. Previous literature data are also provided here, as well as given in Table 1. FIG. 2D shows that in solar reflectance of hBN-Acrylic, the simulation results agree well with the experiments. Two different single sizes were used, diameters of 300 nm and 350 nm. In FIGS. 2A through 2D it can be seen that radiative cooling performance, including daytime subambient cooling, is optimized in materials by achieving high reflectance in the solar spectrum of 250-2500 nm and a high emittance in the sky window of 8-13 μm. In coatings and paints, this can be achieved by designing the material based on the properties of the nanoparticle filler and matrix. The acrylic matrix not only helps to provide ease of use and improved reliability in application, but also contributes to the high sky window emissivity. The hBN-Acrylic coatings of the present invention showed excellent solar reflectance at various layer thicknesses. At 150 micrometers, the coating's solar reflectance begins to saturate at 97.9% and the emissivity was measured at 0.83, seen in FIG. 2A. At 70 micrometers, the solar reflectance was still 90.9% and the sky window emissivity was 0.78, as seen in FIG. 2B. FIG. 2C shows the solar reflectance measured as a function of thicknesses, including 91.6%, 92.1%, 93.0%, 95.0%, and 98.2% for 80, 110, 120, 130, and 350 micrometer-thick coatings, respectively. Saturation of reflectance at higher coating thickness, as seen in FIG. 2C, demonstrated that for maximum solar reflectance, the coating 20 does not need to be thicker than about 150 micrometers. FIG. 2C also shows that at about 150 μm thickness, the hBN-acrylic nanoporous paint 20 achieves comparable or higher solar reflectance than previous best radiative cooling paints and films, but the thickness was reduced by 50% or more. FIG. 2D shows a comparison between the experimental solar reflectance with Monte Carlo simulation data, which will be described in detail subsequently.

To obtain the spectral characterizations, the optical properties of the samples 22 were characterized in both the UV-Vis-NIR and IR wavelengths using spectrometers. For the UV-Vis-NIR characterization, a Perkin Elmer Lambda 950 spectrometer with an integrating sphere was used along with a Spectralon diffuse reflectance standard. The characterization in the IR wavelengths was performed on a Nicolet iS50 FTIR spectrometer with a PIKE integrating sphere and a PIKE Technologies diffuse reflectance standard. A 1 mm thick glass plate substrate was used for the UV-Vis-NIR measurements to prevent contribution of the substrate to reflectance, and a 1-mm thick aluminum sheet substrate was used for the IR measurements to avoid contribution of the substrate to emissivity. Although a freestanding sample or IR-transparent substrate is preferred for sky window emissivity measurements, this was not successfully attained at this point yet and will be attempted in the future. The spectral reflectance R_{λ} and transmittance T_{λ} from 0.25-20 micrometers were measured and quantified, and the spectral absorptance A_{λ} was calculated from measured values by A_{λ}=1−R_{λ}−T_{λ}. The sky window emissivity was calculated by first obtaining the absorptance at each wavelength from the measured reflectance and transmittance values, and then finding the total absorptance within the sky window, pertaining to 8-13 micrometer wavelengths.

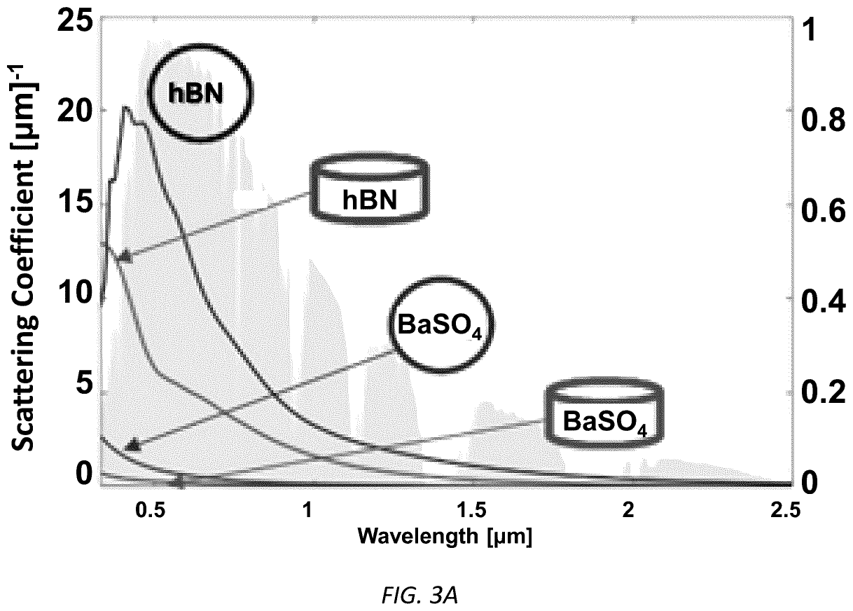

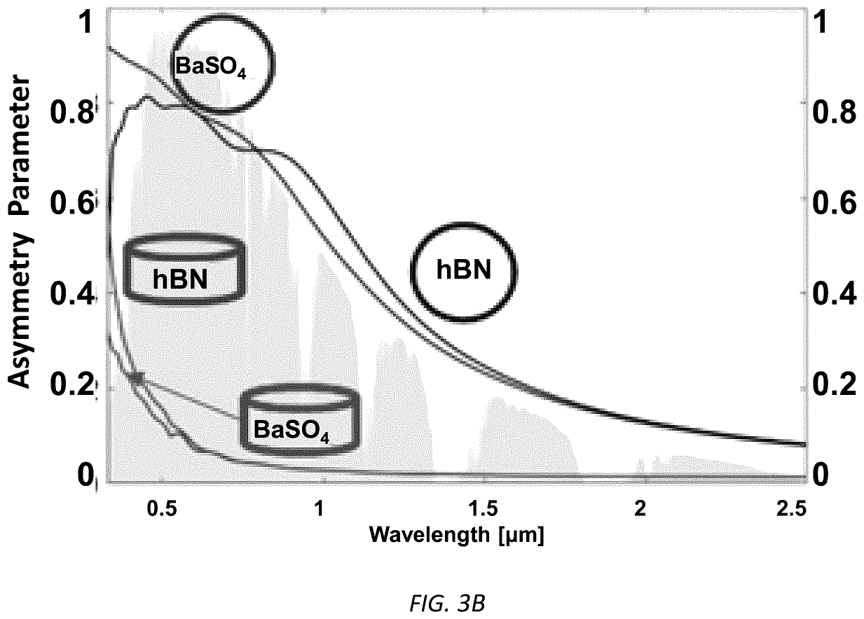

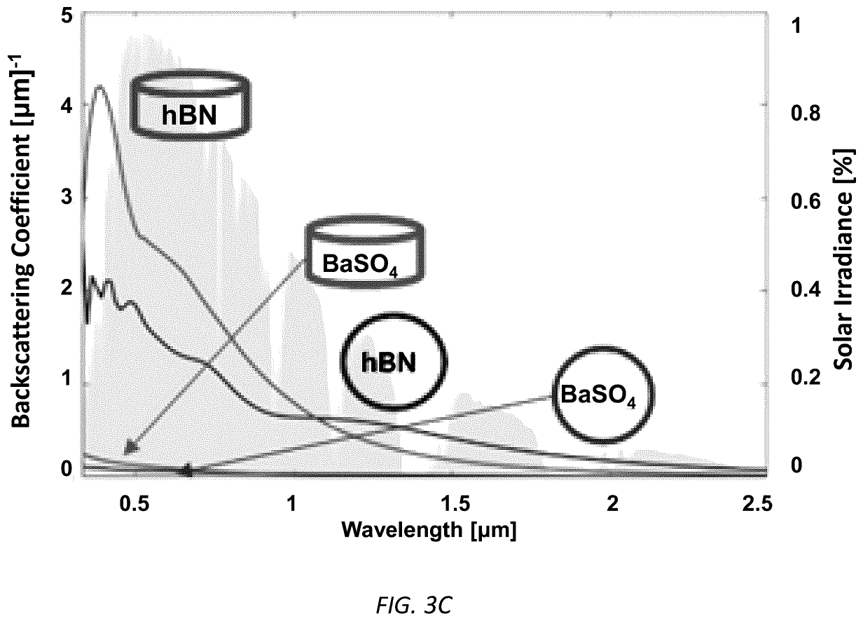

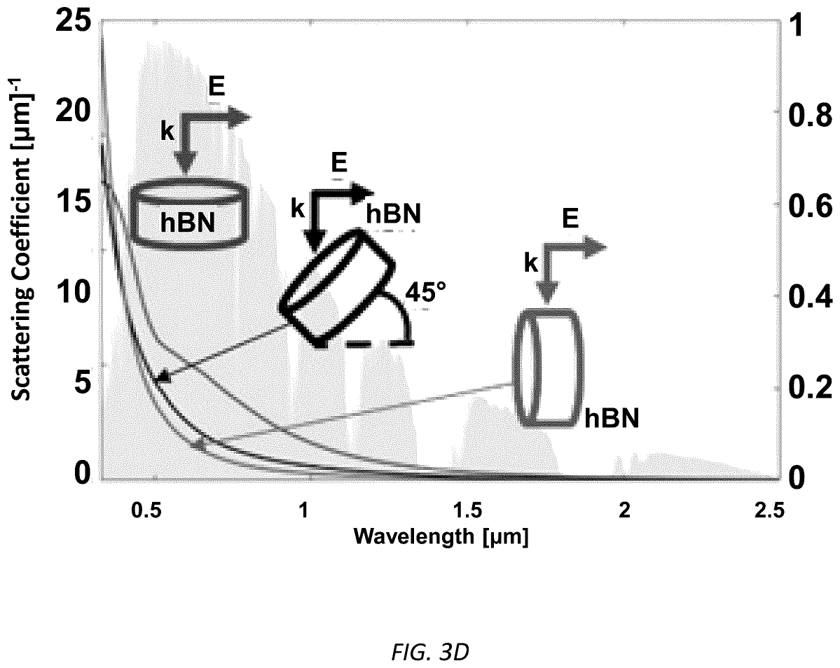

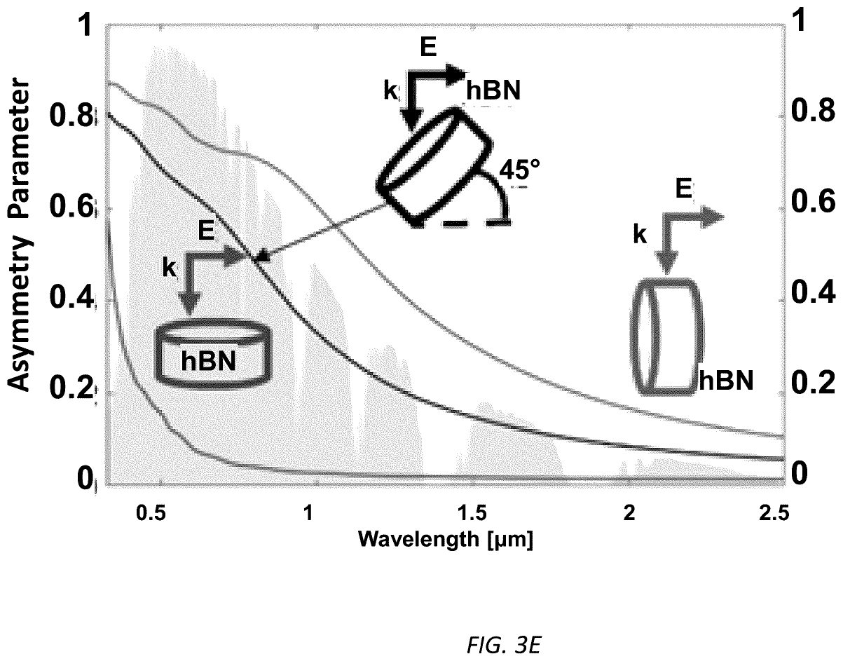

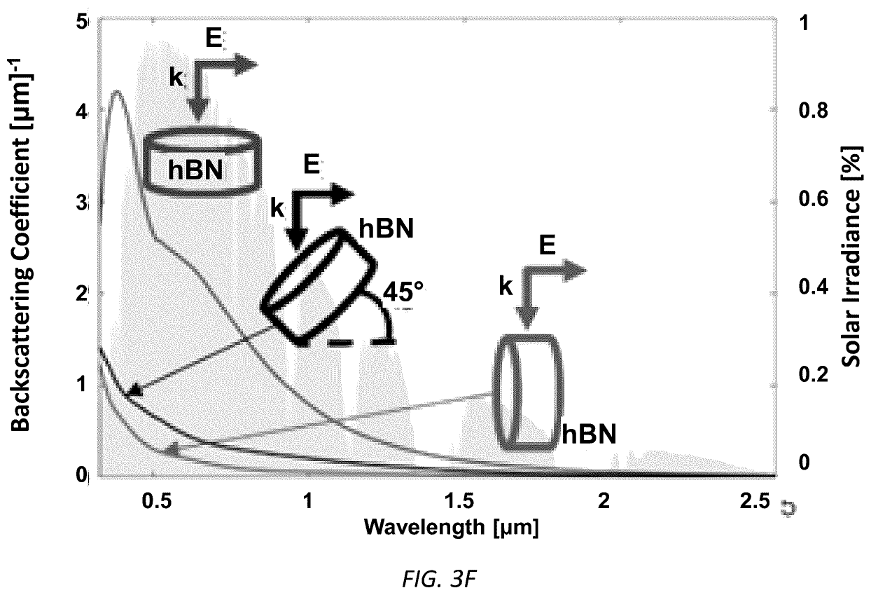

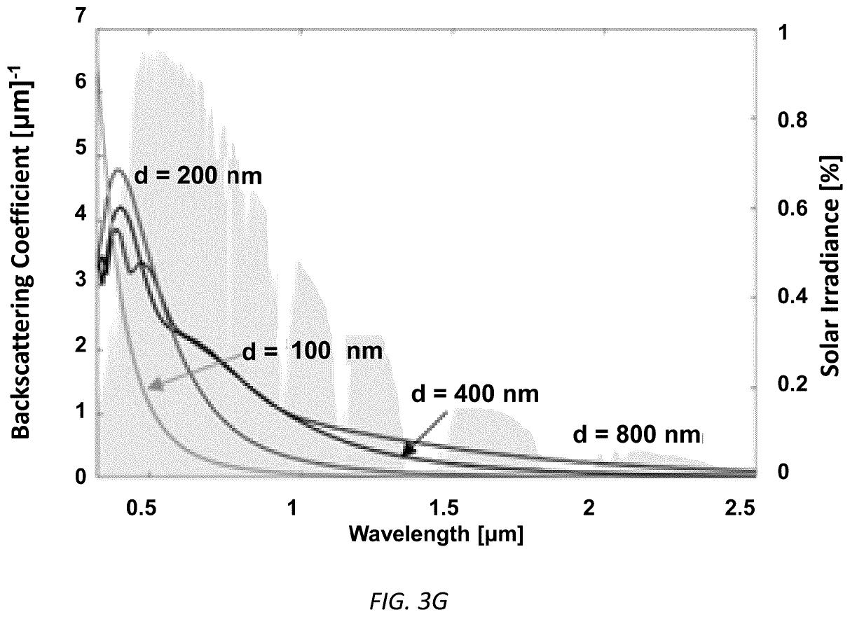

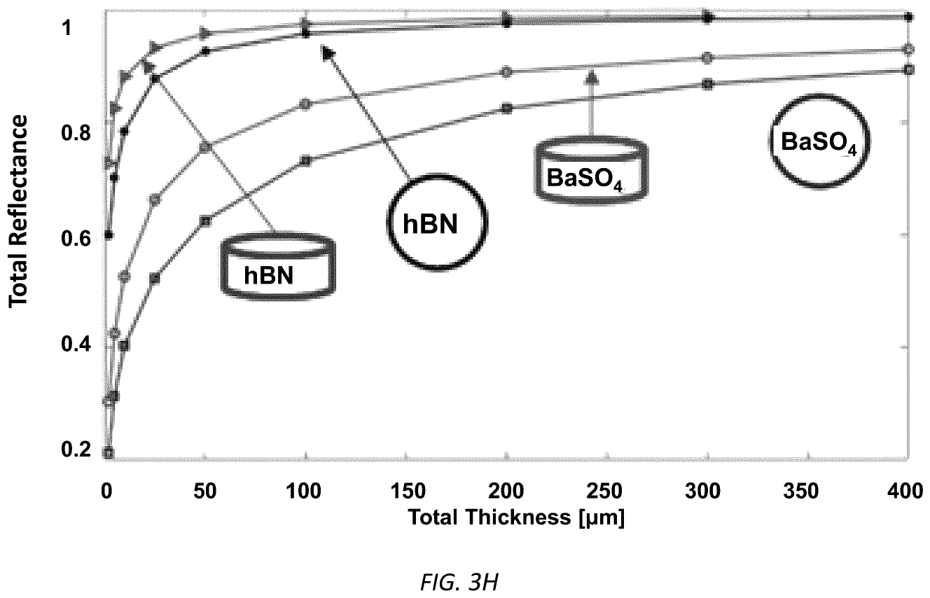

In FIG. 3A shows scattering coefficient of four different particles, with different morphology and refractive index. The spherical BaSO₄ (brown), the platelet hBN (green), the platelet BaSO₄ (red) and the spherical hBN (blue). FIG. 3B shows the asymmetry parameter of the four particles. FIG. 3C shows the backscattering coefficient of the four particles. FIG. 3D shows the scattering coefficient of platelet hBN with varying orientations, including in-plane (green), 45 degrees (black) and cross-plane (light blue). FIG. 3E shows the asymmetry of platelet hBN with varying orientations. FIG. 3F shows the backscattering coefficient of platelet hBN with varying orientations. FIG. 3G shows the backscattering coefficient of hBN with different diameters of 100, 200, 400 and 800 nm. FIG. 3H shows the predicted total reflectance as a function of the total coating thickness of the four different particles, including the spherical BaSO₄ (brown) and the platelet hBN (green), as well as the two imaginary particles, the platelet BaSO₄ (red) and the spherical hBN (blue). To explain the ultra-high solar reflectance achieved for such a thin paint layer, the scattering coefficient and asymmetry parameter were calculated for hBN nanoplatelets using COMSOL, and the results were compared to those for BaSO₄ spherical nanoparticle in FIGS. 3A and 3B. Both nanoparticles have the same diameter of 370 nm, while the thickness of the platelets was 50 nm. hBN nanoplatelets show higher scattering coefficient (FIG. 3A) and lower asymmetry parameter (i.e., more backscattering) (FIGS. 3B and 3C) in the in-plane direction in the entire spectrum than spherical BaSO₄, the previous state-of-the-art. This result was significant and surprising. The asymmetry parameter gives important insights related with the form of scattering. It is close to unity when the backscattering is very narrow; this is known as geometric scattering. In contrast, the asymmetry parameter is close to zero when Rayleigh scattering occurs. For spherical particles, Mie scattering is usually favorable for achieving high reflectance because it provides high scattering coefficient; however, a drawback is the weaker backscattering. On the other hand, Rayleigh scattering offers equal backward and forward scattering; however, the scattering coefficient is too small. A natural question is whether the high, Mie scattering-like scattering coefficient and the strong, Rayleigh scattering-like backscattering can be achieved simultaneously. Clearly it is not feasible with spherical particles. However, this was achieved with the proposed hBN nanoplatelets of the present disclosure. The backscattering coefficient of two imaginary particles, spherical hBN and platelet BaSO₄, was also studied to systematically understand the respective roles of the refractive index and the particle morphology. The spherical hBN has a higher scattering coefficient than the platelet hBN; however, the platelet-shaped particle's lower asymmetry parameter results in a stronger backscattering coefficient in the ultraviolet, visible, and infrared wavelengths (FIG. 3C), indicating that the platelet morphology was more favorable than the spherical one, aside from refractive index. The results indicate that higher refractive index enhances the scattering coefficient, and the nanoplatelet morphology compromises the scattering coefficient slightly but overall enhances backscattering and eventually the backscattering coefficient, as compared to BaSO₄ spherical nanoparticles. As for the platelet orientations, the scattering coefficient (FIG. 3D), asymmetry parameter (FIG. 3E), and back-scattering coefficient (FIG. 3F) were studied for both the in-plane and cross-plane orientations, as well as a 45-degree angle between them. The angled orientation was overall lower in all values compared to the in-plane (horizontal) orientation and higher than the cross-plane (vertical) orientation. FIG. 3G shows the backscattering coefficient of hBN of various sizes (diameter of 100, 200, 400 and 800 nm with constant thickness of 50 nm). Each nanoplatelet diameter peaks the backscattering coefficient at distinct wavelength bands, implying the high variability in nanoparticle sizes can enhance the total reflectance. Surprisingly, Rayleigh scattering-like asymmetry parameter was detected for hBN nanoplatelet at most of the regions including visible and infrared spectrum, regardless of size resulting in prominent backscattering. This was favorable for high solar reflectance. The total reflectance of the four particles in FIGS. 3A through 3C was also calculated by using the Monte Carlo method, and the results are shown in FIG. 3H. The solar reflectance in the order from high to low were nanoplatelet hBN, spherical hBN, nanoplatelet BaSO₄, and spherical BaSO₄, indicating both high refractive index and nanoplatelet morphology favor high solar reflectance and explain why hBN nanoplatelet-acrylic paints outperform BaSO₄-acrylic paints in solar reflectance. As shown in FIG. 2D, the simulated solar reflectance on the nanoplatelet hBN agree with the experimental data reasonably well. Assumptions were used to simplify the Monte Carlo model. No air pores were included in the nanocomposite as was observed from the SEM images, and nanocomposite consists of only single-size particles. These could result in an underprediction of total reflectance. On the other hand, the Monte Carlo method only uses scattering coefficient of light vertically incident on the hBN nanoplatelets while no angular dependency is considered. This would cause overprediction of scattering and reflectance for an anisotropic material like hBN platelets. The agreement of the total solar reflectance between the experimental and Monte Carlo simulations, despite of capturing the main physics, may be partly due to error cancellation and hence should be interpreted with caution.

The backscattering coefficient was estimated in accordance with the following. Mie theory is an analytical solution and is widely used for the calculation of the scattering of a plane electromagnetic wave by homogeneous spherical particles and infinite cylinders. A different method is needed for better approximation of the scattering coefficient and the asymmetry parameter of platelet particles, such as hBN nanoplatelets. For the present disclosure, Maxwell's equation was solved by using Finite Element Method (FEM) and COMSOL Multiphysics. For a homogeneous and linear medium, the electric field (E) in the frequency domain is given as

$$∇ \times ( ∇ \times E ) - {k}_{0}^{2} {ϵ}_{r} E = 0 \qquad ( Eq . 2 )$$

where k₀ is the wavenumber in free space and ∈ᵣ is the relative permittivity. The light wave is mathematical approximated by a plane wave with the boundary condition

$$n \times [ ∇ \times ( E + {E}_{b} ) ] - jk n \times ( E \times n ) = 0 \qquad ( Eq . 3 )$$

where k is the wavenumber E_{b} is the scattered field defined as

$${E}_{b} = {E}_{0} exp ( - \frac{2 π jz}{λ} ) \hat{x} ,$$

E₀ is the electric field magnitude, and λ is the wavelength. The cross-section scattering (σ_{sc}) and the asymmetry parameter (g) are defined as

$${σ}_{sc} = \frac{\int {\int }_{S} n \cdot P dS}{{S}_{in}} , \qquad ( Eq . 4 )$$

$$and$$

$$g = \frac{\int {\int }_{S} cos θ ( n \cdot P ) dS}{\int {\int }_{S} n \cdot P dS} , \qquad ( Eq . 5 )$$

where P is the power flow,

$${S}_{in} = \frac{{E}_{0}^{2}}{2 {Z}_{0}} ,$$

Z₀ is the impedance of free space and cos θ=n·k. From these values, the total and back scattering coefficients can be estimated.

The solar reflectance measured for the 150-micrometer paint layer 20 of the present invention was similar to that accomplished with recent state-of-the-art ultrawhite BaSO₄ coatings, while at only 38% of the thickness. Further, the density of hBN is 2.1 g/cm³, which is less than half of BaSO₄ at 4.5 g/cm³, hence the weight of the hBN-Acrylic coating is only 20% of that of the BaSO₄ coating reported elsewhere. Moreover, at 350 micrometers, 50 micrometers less than the 400-micrometer thickness required to reach 97.9% in previous work, 98.2% solar reflectance was measured. The measured solar reflectance values were also significantly higher than current heat-reflective paints, which achieved a maximum of 91% solar reflectance.

The sky window emissivity for the hBN-Acrylic paints 20, at a value of 0.83, was relatively lower due to the lack of the sky window infrared-active phonon modes that contributes to emissivity in BaSO₄-Acrylic paints. However, during the daytime, the sky window emissivity had a much smaller role than the solar reflectance, and this was explained as follows. The overall radiative cooling capabilities of materials can be more fairly compared using the developed RC Figure of Merit, defined as:

$$RC = {ε}_{sky} - r ( 1 - {R}_{solar} ) \qquad ( Eq . 6 )$$

In this equation, ε_{sky} is the total sky window emissivity, r is the ratio of solar irradiation power over the blackbody surface emissive power in the sky window and is recommended to be set as ˜7.14, assuming a standard 1000 W/m² solar irradiation power and 140 W/m² blackbody surface emissive power in the sky window, and Rₛₒₗₐᵣ is the total solar reflectance. The physical meaning of RC is that its multiplication with the blackbody surface emissive power in the sky window would yield the net radiative cooling power. From this definition, every 0.01 increment in the solar reflectance is equivalent to 0.0714 increment in the sky window emissivity in terms of the cooling performance. This RC figure of Merit shows that cooling below ambient can in principle be achieved when RC is positive. For an hBN-Acrylic layer of 150 micrometer thickness, the RC was calculated at 0.68 demonstrating 68% radiative cooling capability over the theoretical limit. This was calculated from the 97.9% total solar reflectance measured for a 150-micrometer layer on a 1-mm glass substrate, and the 0.83 sky window emissivity calculated from measurements for a 150-micrometer layer on a 1-mm aluminum substrate. This can be compared to previous RC figures of Merit for TiO₂-Acrylic, CaCO₃-Acrylic, BaSO₄ films, and BaSO₄-Acrylic paint of 0.18, 0.62, 0.79, and 0.82 respectively. It can also be compared to recent non-paintable approaches, which show RCs of 0.32, 0.53, 0.35, and 0.57. The RC for the hBN-Acrylic paints if the present disclosure was among the highest calculated.

Furthermore, as a method to compare the performances of different materials while normalizing to layer thickness, a modified form of the originally given Figure of Merit was proposed:

$${RC}_{t} = [ {ε}_{sky} - r ( 1 - {R}_{solar} ) ] ( 1 - t / {t}_{o} ) , \qquad ( Eq . 7 )$$

where RCₜ is the radiative cooling figure of merit with thickness taken into consideration, t is the layer thickness, and tₒ is the maximum considered layer thickness (1 mm is recommended, as radiative cooling coatings are typically engineered to be below this thickness). This F.O.M. is a rough approximation, and a truly accurate figure would likely involve a much more complicated expression. However, it can be used to roughly compare different materials. Using 1.5 mm for tₒ, RCₜ was calculated for various materials: 0.453 for CaCO₃-Acrylic Paints, 0.132 for TiO₂-Acrylic Paints, 0.701 for BaSO₄ films, 0.597 for BaSO₄-Acrylic Paints, and 0.612 for the studied hBN-Acrylic Paints.

For easier comparison, Table 1 shows properties of various materials proposed in literature as well as those of the hBN-Acrylic paints 20 disclosed herein. Compared to the BaSO₄-Acrylic paint that shows 98.1% solar reflectance, the hBN-Acrylic paint of this disclosure shows 97.9% solar reflectance, but the thickness and weight were reduced by 62.5% and 78.4% respectively. Even when compared to the porous polymers that show 96% solar reflectance, the hBN-Acrylic paint 20 of this disclosure shows higher solar reflectance while the thickness and weight were still reduced by 50% and 45.3% respectively. Thus, the hBN paint 20 of this disclosure has the advantage in lowest thickness, lowest weight, and among the highest solar reflectance and quite high sky window emissivity, resulting in having the highest RCₜ value amongst the compared materials.

TABLE 1
Summary and comparison of the hBN-Acrylic paint of the present disclosure
and previous radiative cooling materials in literature

| | | | Total | | Feature | Total | Sky | |
|---|---|---|---|---|---|---|---|---|
| Material | Main | Thickness | Density | Weight | Size | Solar | Window | |
| Type | Component | (μm) | (g/cm³) | (g/cm³) | (nm) | Reflectance | Emissivity | RCt |
| hBN-Acrylic | Boron Nitride | 150 | 1.9 | 0.029 | 332 | 97.9% | 0.83 | 0.612 |
| Paint | (60% volume | | | | | | | |
| (Proposed) | loading) | | | | | | | |
| BaSO₄-Acrylic | Barium Sulfate | 400 | 3.34 | 0.134 | 500 | 98.1% | 0.95 | 0.597 |
| Paint | (60% volume | | | | | | | |
| | loading) | | | | | | | |
| TiO₂-Acrylic | Titanium Oxide | 400 | 3.18 | 0.127 | 100 | 89.5% | 0.93 | 0.132 |
| Paint | (8% volume | | | | | | | |
| | loading) | | | | | | | |
| CaCO₃-Acrylic | Calcium | 400 | 2.23 | 0.089 | 500 | 95.5% | 0.94 | 0.453 |
| Paint | Carbonate (60% | | | | | | | |
| | volume loading) | | | | | | | |
| Porous | Poly(vinylidene) | 300 | 1.77 | 0.053 | 200, 5500 | 96% | 0.97 | 0.547 |
| Polymeric | fluoride-co-hexa- | | | | | | | |
| Coating | fluoropropylene | | | | | | | |
| hBN Photonic | Boron Nitride | 1400 | — | — | 900 | 98% | 0.89 | 0.05 |
| Film | (40.5% volume | | | | | | | |
| | loading) | | | | | | | |

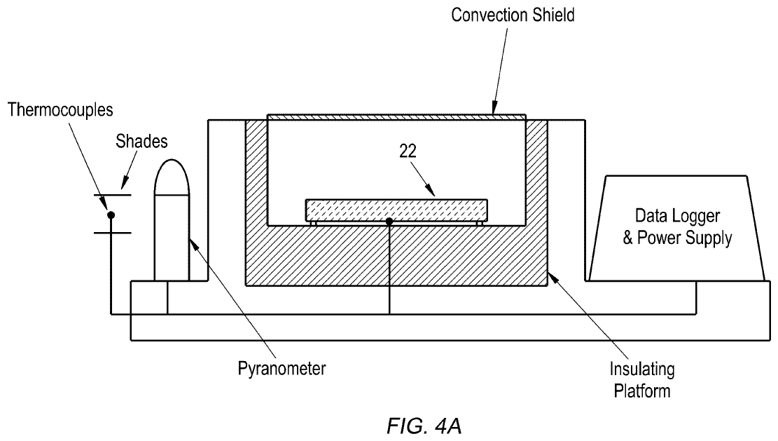

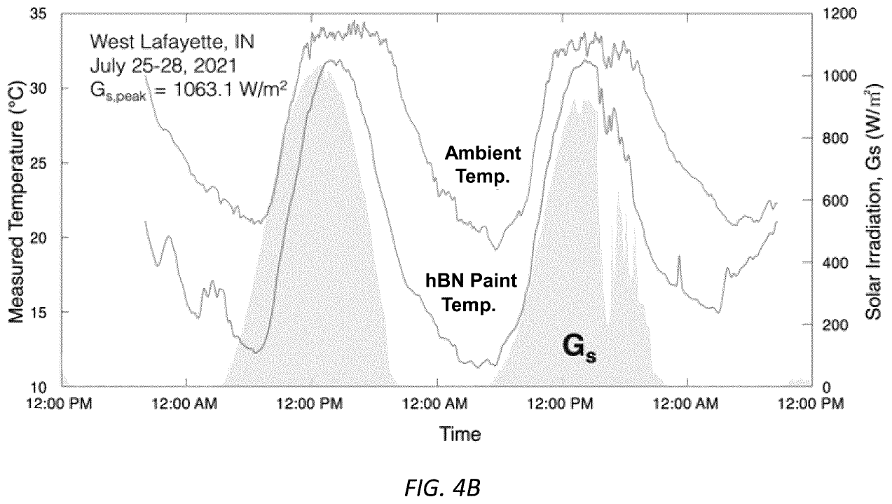

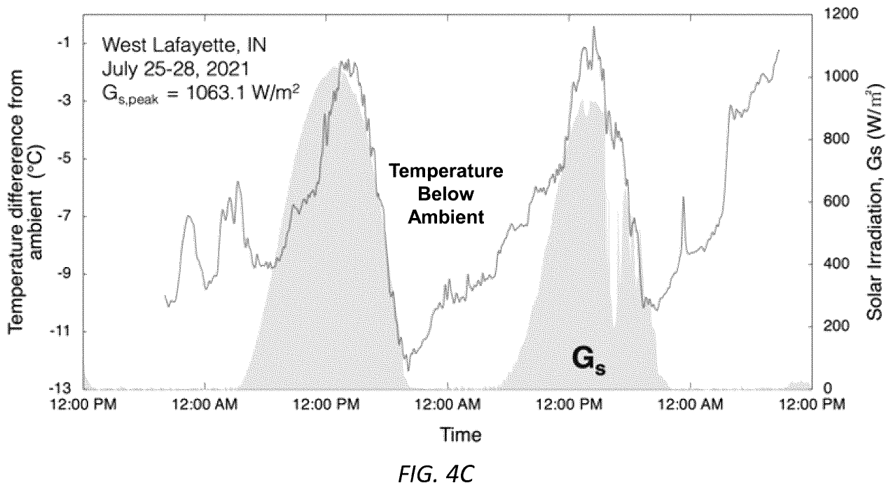

Outdoor testing was performed to demonstrate the radiative cooling capability of the hBN-Acrylic coatings 20 of the present disclosure. In FIG. 4A shows a schematic and picture of the field setup for these tests. A sample 22 was placed in a Styrofoam insulating platform to reduce ground heating effects, and two vertical transparent shields and one horizontal transparent shield, made from thin polyethylene film, were used around the sample to reduce forced convection loss. T-type thermocouples were used to collect temperature data of the bottom of sample, which was raised from the platform to avoid conduction loss, and the ambient, which was captured using a shaded thermocouple to avoid falsely high ambient temperature data from thermocouple overheating. The direct and diffuse solar irradiation was captured by the pyranometer. FIG. 4B shows temperature over time of the sample surface, as well as of the ambient surroundings, from outdoor experiments over three consecutive days from Jul. 25-28, 2021. The measured average dew point for this period was 19.2±1.2° C., and relative humidity was 72.9±19.3%. The test was performed with samples with an average of 140 micrometer-thick 60% hBN-Acrylic coatings on 1 millimeter aluminum sheets of approximately 2×2 inches. Samples were coated via pouring and checked for consistency in layer thickness at several points throughout the surface. Data demonstrated a moving average over 10-minute increments of the measured data. FIG. 4C shows temperature difference between the ambient surroundings and the sample surfaces. The data demonstrate moving average over 10-minute increments of the measured data. The ambient temperatures during outdoor tests vary between 20-30° C. and the sample temperature was consistently lower than the ambient during daytime and nighttime (FIG. 4B). The average temperature difference from the ambient of 6-8° C. was achieved (FIG. 4C). Under the peak solar irradiation of 1,063 W/m2, the sample can remain approximately 1-2° C. cooler than the ambient owing to the high solar reflectance. The total sky window emittance of 0.83 results in a maximum temperature difference of 12° C. observed during the clear night on Jul. 26, 2021.

For the field tests of the radiative cooling performance, the radiative cooling performance of the samples 22 was characterized by simultaneously monitoring sample temperature, ambient temperature, and solar irradiation. With reference to FIG. 4A, T-type thermocouples were attached to the back of the samples 22 and suspended underneath the table to monitor the sample and ambient temperatures. The samples 22 were placed in an insulating Styrofoam box and covered by a 12 μm PE film to mitigate conduction and convection loss without blocking the radiative heat exchange. The ambient temperature was used to calculate cooling below ambient, as using air temperature in the sample compartment would overestimate the cooling capacity and weather station temperature would underestimate it. The solar irradiation was monitored by a pyranometer. The data collection occurred every minute and a moving average of 10 minutes intervals was plotted.

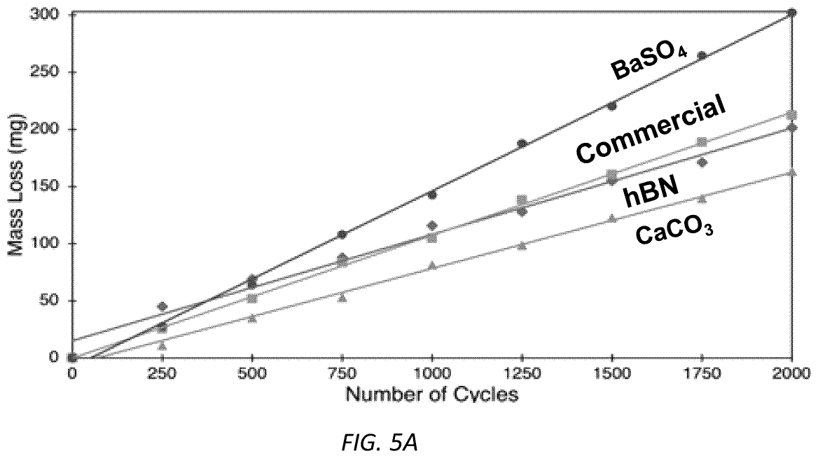

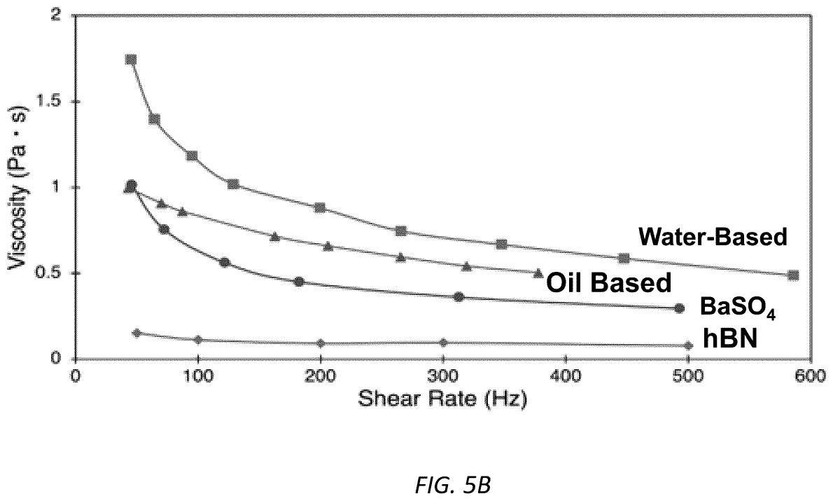

An important aspect of radiative cooling coatings is the feasibility of application, as well as the durability in outdoor use. With reference to FIG. 5, the 60% hBN-Acrylic samples of the present disclosure, made to 150 micrometer layer thickness on 1-mm aluminum sheet substrates, were subjected to several tests to demonstrate adequate performance in these regards. In FIG. 5A shows abrasion testing results for hBN paint 20 (denoted as boron nitride) compared to commercial paints and previously developed calcite-based and barite-based paints. Measurements of sample mass loss over 2000 cycles were demonstrated. FIG. 5B shows viscosity testing for hBN paint 20 (denoted as boron nitride) compared to commercial oil-based and water-based paints, as well as previously developed barite paint. Measurements of the viscosity were performed at several shear rates from 10 to 600 s-1 for each sample. In FIG. 5A, the samples were tested for mass-loss while undergoing 2000 cycles of abrasion testing. Over this range, the mass loss experienced by the hBN-Acrylic coating 20 of the present disclosure was comparable with that of commercial white paint, and slightly outperforms previously developed calcite paints. These results show that the wear of the coatings 20 of the present disclosure was similar to materials currently in use, and therefore demonstrate that the material of the present disclosure meets existing material performance in its resistance to mass loss from abrasion. Another aspect of concern in outdoor use is exposure to water. The samples with hBN-Acrylic coating 20 of the present disclosure were tested for water resistance by being submerged in circulating water for 24 hours. The samples were weighed before the experiment, as well as after 24 hours of drying time in the fume hood after the experiment. A net-zero mass loss was calculated, demonstrating good water resistance.

The durability properties of the samples were characterized to represent various conditions representative of real-world use and application. Abrasion tests were conducted using a Taber Abraser Research Model and performed following ASTM D4060 guidelines. Two CS-10 abrasive wheels with a loading of 250 grams per wheel were placed on the surface of a 150-micrometer thick layer of coating on a 1 mm flat aluminum sheet. The samples were weighed prior to testing and reweighed every 250 cycles to quantify mass loss. According to the ASTM D4060 standard, the wheels were also resurfaced every 500 cycles for consistency. Mass loss was measured over a total 2000 of cycles. Overall wear was compared with coatings commonly used in similar applications. In order to characterize the usability for various application techniques, the viscosity of the 60% hBN-Acrylic coating 20 was also measured across using a RheoSense Inc. microviscometer. At a consistent sample temperature of 23° C., the viscosity of a 50-microliter sample of coating was measured across 5 discrete shear rates over a range of 50-500 s⁻¹. The results were compared with coatings commonly used in similar applications. The potential effects of rain and other water exposure were also considered by following water resistance testing of coatings techniques as described in ASTM D870. A 2 by 2 inch 1-mm thick flat aluminum sheet was coated with 150 micrometers of hBN-Acrylic paint. The sample was then held in place fully submerged in a large container of gently circulating water (stirred at 280 rpm) with no contact with container walls. This setup was left in place for 24 hours, with mass of sample being measured before testing. The mass was once again measured after allowing sample to dry for 24 hours in a fume hood and the net mass loss was calculated.

To demonstrate ease and versatility of application techniques for the hBN-Acrylic coatings 20, a viscosity test was carried out and result were compared to commercial paints and previously developed barite paint. The viscosity was measured at constant sample temperature throughout and at various shear rates in the range of 50 and 500 s⁻¹. The hBN-Acrylic paint 20 of the present disclosure showed slight shear thinning, as well as a relatively lower viscosity compared to other paints. However, it remains within the industry recommended range of viscosities for brushing application of paints and coatings.

There are significant benefits of the thinness and light weight of the hBN-Acrylic paint 20 of the present disclosure. For example, although the cost of hBN nanoplatelets is higher than that of BaSO₄ nanoparticles, there is still significant benefit to a lightweight, thin paint layer of hBN in weight-sensitive applications requiring radiative cooling, such as aerospace technologies, airplanes, vehicles, and wearable technology. In wearables, typically only a small amount of lightweight coating is needed. In aircraft, seemingly small reductions in weight can result in significant decreases in fuel consumption and related CO₂ emissions. For example, the inventors estimate that if the hBN-Acrylic paint rather than BaSO₄-Acrylic paint is used on all the 23,000 airplanes in operation globally, the total fuel savings would be 340,000 metric tons and the CO₂ emission reduction would be approximately 1 million metric tons on a yearly basis. In terms of the thickness, each coat by brush or roller only adds 50-75 micrometers of paint when dried and more than 5-8 coats would be needed to reach 400 μm or mm-thick layers that have previously been needed. With the 150-micrometer thick hBN paint 20 disclosed in this application, the thickness of radiative cooling paints was brought to the common practical range, and only two coats were needed on average. For at least these reasons, the light weight and thinness of the compositions 32 and coatings 20 of the present disclosure are a significant innovation. It provides a feasible option for a critical challenge of radiative cooling paints in many practical applications. The thin, lightweight ultra-white paint introduced in this work is expected to make a major impact in the field.

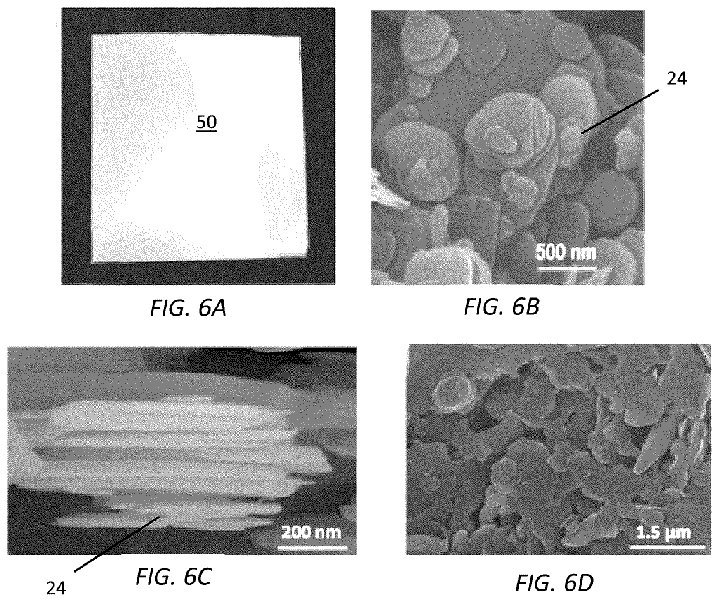

FIG. 6 shows aspects of another example radiative cooling coating 50 according to some nonlimiting aspects of the invention. hBN-Acrylic coatings 50 at a range of different thicknesses were designed and fabricated. The coatings were loaded with a 60% volume concentration of hBN nanoplatelets 24. DMF solvent 26 was added to the mixture at a 1:6 ratio. Samples were prepared by pouring even layers onto flat glass or aluminum substrates and allowed to fully dry in a fume hood. FIG. 6A shows a 60% hBN-Acrylic paint 50 coated on an aluminum sheet. The coating was 150 μm thick and the aluminum sheet was a 750 μm thick 4-inch square. SEM imaging was used to determine nanoplatelet morphology, orientation, and observe their dispersion throughout the acrylic matrix. As seen from FIGS. 6B and 6C, the nanoplatelet structure of the hBN coating 50 has a high aspect ratio (diameter to thickness) and directional properties and a high degree of variability in diameter. The high aspect ratio was consistent throughout the nanoplatelets. FIG. 6B show an SEM image of the hBN nanoplatelets (top view) from the paint 50. The particle diameter distribution was determined based on the SEM images to be 372±193 nm. FIG. 6C shows an SEM image of the hBN nanoplatelets (side view) of the paint 50. The particle thickness distribution was determined based on the SEM images to have a fairly uniform distribution of 45±3 nm with. The acrylic matrix that encapsulates and bonds the nanoplatelet filler gives the material improved reliability under various conditions due to the polymer-filler composition similar to the majority of commercially available paints. FIG. 6D shows an SEM image of the hBN-acrylic nanocomposite coating 50 with 60% nanoplatelet concentration. To produce the radiative cooling coatings 50 of FIG. 6, the method 100 described hereinbefore was implemented, with the exception that, samples were poured in even layers onto 1 mm thick glass slides and 750-micrometer aluminum plates.

It is believed that, for the composition of FIG. 6, the higher refractive index, nanoplatelet morphology, broad diameter distribution, and a high hBN nanoplatelet volume concentration of 60% together help to achieve ultra-effective scattering of the sunlight and an exceptional solar reflectance of 98.1% at only 150-micrometer layer thickness. While achieving the same solar reflectance as the state-of-the-art BaSO₄ ultrawhite paint, it represents a layer thickness reduction by 62.5% and weight reduction by 80%. The sky window emissivity was 0.83. The hBN-acrylic paint demonstrated solar reflectance values among the highest achieved by radiative cooling materials at a fraction of the thickness and weight, with the addition of being easily scalable and versatile. The optical properties that yield an exceptionally high solar reflectance also give an ultrawhite appearance to the hBN-Acrylic coatings.

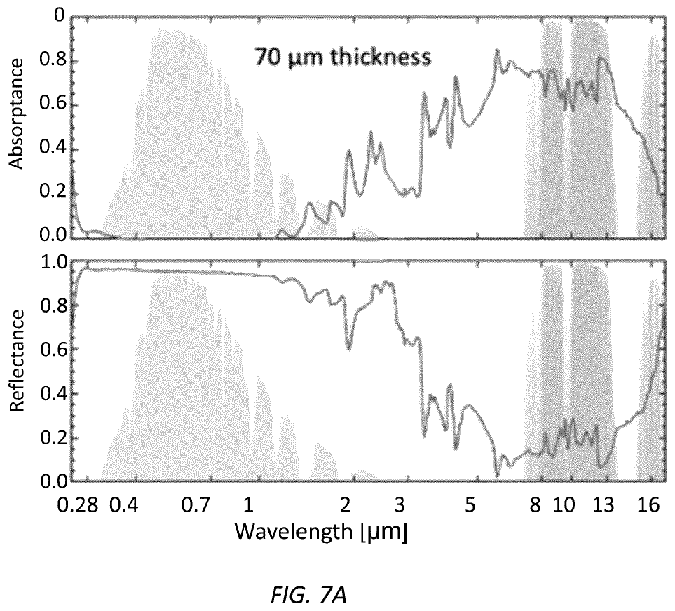

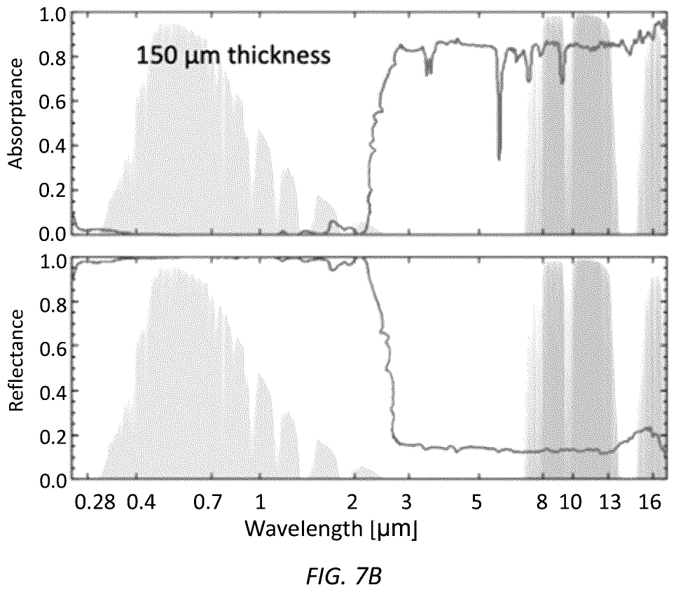

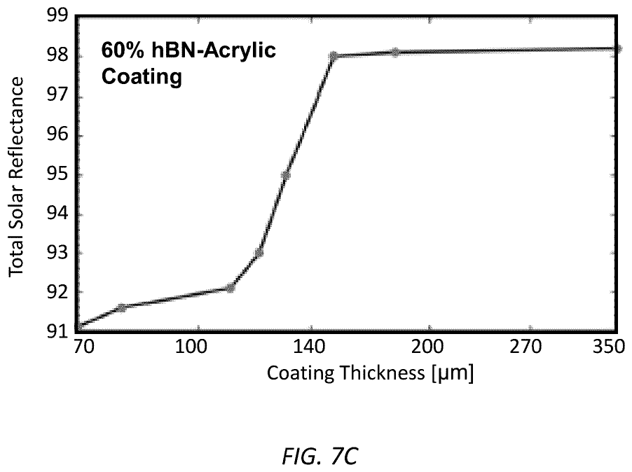

In FIG. 7A shows spectral characterization of a 70-micrometer thick layer of hBN-Acrylic coating from FIG. 6. The total solar reflectance was 91.0% and the total sky window emissivity was 0.78. Measurements for the wavelength range of 0.25-2.5 micrometers were performed with a 1 mm thick glass substrate to avoid reflectance from the substrate, and measurements from 2.5-20 micrometers were performed with a 0.75 mm thick aluminum substrate to avoid emissivity from the substrate. FIG. 7B shows spectral characterization of a 150-micrometer thick layer of hBN-Acrylic coating of FIG. 6. The total solar reflectance was 98.1% and the total sky window emissivity was 0.83. Measurements from 0.25-2.5 micrometers were performed with a 1 mm thick glass substrate and measurements from 2.5-20 micrometers were performed on a 0.75 mm thick aluminum substrate. FIG. 7C shows the total solar reflectance as a function of the thicknesses of the coating of FIG. 6. All samples were measured on 1 mm thick glass substrates. The optical properties of the samples were characterized in both the UV-Vis-NIR and IR wavelengths using spectrometers. For the UV-Vis-NIR characterization, a Perkin Elmer Lambda 950 spectrometer with an integrating sphere was used along with a Spectralon diffuse reflectance standard. The characterization in the IR wavelengths was performed on a Nicolet iS50 FTIR spectrometer with an integrating sphere and a PIKE Technologies diffuse reflectance standard. A 1 mm thick glass plate substrate was used for the UV-Vis-NIR measurements, and a 750-micrometer thick aluminum sheet substrate was used for the IR measurements. The reflectance and transmittance for each individual wavelength from 0.25-20 micrometers were measured and quantified.

The hBN-Acrylic coatings 50 of FIG. 6 showed excellent solar reflectance at various layer thicknesses. At 70 micrometers, 91.1% solar reflectance and 0.78 emissivity was accomplished (FIG. 7A), and at 150 micrometers, the coating's solar reflectance begins to saturate at 98.1% and the emissivity was measure at 0.83 (FIG. 7B). FIG. 7C shows the solar reflectance measured for other thicknesses, including 91.6%, 92.1%, 93.0%, 95.0%, and 98.2% for 80, 110, 120, 130, and 350 micrometer-thick coatings, respectively. Saturation of reflectance at higher coating thickness, as seen in FIG. 7C, demonstrated that for maximum solar reflectance, the coating does not need to be thicker than 150 micrometers. The solar reflectance measured for the 150-micrometer coating was identical to that accomplished with the recent state-of-the-art ultrawhite BaSO₄ coating while at only 38% of the thickness. Further, the density of hBN was 2.1 g/cm³, which is much smaller than that of BaSO₄ at 4.5 g/cm³, hence the weight of the hBN-Acrylic coating was only 20% of that of the BaSO₄ coating reported in literature. Moreover, at 350-micrometer thickness, 50 micrometers less than the 400-micrometer thickness required to reach 98.1% in previous work, the measured solar reflectance was 98.2%. The measured solar reflectance values measured for this paint compositions were also significantly higher than current heat-reflective paints, which achieved a maximum of 91% solar reflectance. Thus, these nonlimiting examples of the radiative cooling paints of the disclosure provide a layer thickness reduction by 62.5% and weight reduction by 80% compared to the state-of-the-art BaSO₄ ultrawhite paint at the same solar reflectance.

In this disclosure, hBN has been employed as an ingredient in the radiative cooling paints 20 and 50. However other phases of boron nitride such, as cubic born nitride (cBN), can also give rise to string performance in radiative cooling paints. In addition to hBN nanoplatelets, other materials may also be made, if possible, into nanoplatelet morphologies to enhance their radiative cooling performance. These include but not limited to CaCO₃, BaSO₄, Al₂O₃, and SiO₂.

Application processes for the paint compositions 32 of this disclosure include, but are not limited to pouring, brushing, spraying, screen printing, slot-die and gravure coating. Those skilled in the art will recognize that the viscosity of the paint compositions 32 of this disclosure can be modified and or adjusted to suit a specific application process. Further different application processes will give rise to different thickness ranges and a specific application process can be chosen and tailored to a desired thickness range.

It should be noted that a boron nitride-acrylic paint of this disclosure in some nonlimiting embodiments has a volumetric concentration of 60% and a nanoplatelet morphology with a thickness of tens nanometers and diameter of several hundred nanometers. An ultra-high solar reflectance of 98.1% and high sky window emissivity of 0.83 can be achieved with a thin paint layer of 150 micrometers, which represent a reduction of thickness by 62.5% and weight by 80% as compared to the best available radiative cooling paints based on BaSO₄.

The present application discloses a low-density, high-concentration nanoplatelet-based hBN-Acrylic nanoporous paint 20 and 50 and demonstrates its radiative cooling performance at low coating thickness, as defined by high solar reflectance and high sky window emissivity. At 150 micrometers thickness, the coating achieved a solar reflectance of 97.9% and a sky window emittance of 0.83. These were highly competitive values compared to others reported for greater coating thickness, and among coating and non-coating solutions for radiative cooling that have previously been developed. The weight was only 0.029 g/cm2 due to low density of the hBN nanoplatelets and the acrylic matrix, the dried paint coating 20 and 50 has a porosity of 44.3%, and the thinness of a typical paint layer. The thickness and weight represent significant reductions from previous radiative cooling paints. Furthermore, the radiative cooling paint 20 and 50 of the present disclosure in some arrangements yields an average of 6-8° C. cooling below ambient. It is believed that these results were due to the nanoplatelet morphology, moderately high electron bandgap of the hBN filler at 5.96 eV which eliminates UV absorption and yields higher refractive index, nanoporous nature, as well as the high concentration within the acrylic matrix at 60% volume loading. An average size in the neighborhood of peak solar wavelength and a broad size distribution also were believed to contribute to the high solar reflectance considerably. Abrasion, viscosity, and water resistance testing demonstrate that, in some arrangements, the radiative cooling paint of the present disclosure is durable for outdoor use relative to other coatings and possesses a low viscosity that gives it a high degree of versatility when it comes to application techniques. The low density of the hBN nanoplatelets and the acrylic matrix, and the porosity of 44.3% help the radiative cooling paint 20 and 50 of the present disclosure in some arrangements to achieve a coating paint that is thin and lightweight. As such, it is believed that the radiative cooling paint of the present disclosure could better enable practical applications such as on buildings and automobiles, and light-weight applications such as on aircraft and fabrics.

As previously noted above, though the foregoing detailed description describes certain aspects of one or more particular embodiments of the invention, alternatives could be adopted by one skilled in the art. For example, the compositions and coatings, and their components, could differ in appearance and construction from the embodiments described herein and shown in the drawings, functions of certain components of the compositions and coatings could be performed by components of different construction but capable of a similar (though not necessarily equivalent) function, and various materials could be used in the fabrication of the compositions and coatings, and/or their components. As such, and again as was previously noted, it should be understood that the invention is not necessarily limited to any particular embodiment described herein or illustrated in the drawings.

1. A composition for paint to be used in radiative cooling, the composition in a wet coating phase comprising:
nanoplatelets of hexagonal boron nitride;
an acrylic binder; and
a solvent.

2. The composition of claim 1, wherein the nanoplatelets of hexagonal boron nitride have a diameter between about 120 nm and about 3000 nm and a thickness between about 20 nm and about 1000 nm.

3. The composition of claim 2, wherein the nanoplatelets of hexagonal boron nitride have a diameter between about 130 nm and about 550 nm and a thickness between about 40 nm and about 50 nm.

4. The composition of claim 1, wherein the volume percentage of the nanoplatelets of hexagonal boron nitride is in the range of 3.0-18.0% in the wet coating phase.

5. The composition of claim 1, wherein the acrylic binder comprises an acrylic binding resin.

6. The composition of claim 1, wherein the acrylic binder has a volume percent in the range of 2.0-7.7% in the wet coating phase.

7. The composition of claim 1, wherein the solvent has a volume percent in the range of 80-90% in the wet coating phase.

8. The composition of claim 1, wherein the solvent is dimethylformamide (DMF).

9. A coating of a dried paint on a surface to be cooled by radiative cooling, the coating comprising:
nanoplatelets of hexagonal boron nitride; and
an acrylic binder.

10. The coating of claim 9, wherein the nanoplatelets of hexagonal boron nitride have a diameter between about 120 nm and about 3000 nm and a thickness between about 20 nm and about 1000 nm.

11. The coating of claim 10, wherein the nanoplatelets of hexagonal boron nitride have a diameter between about 130 nm and about 550 nm and a thickness between about 40 nm and about 50 nm.

12. The coating of claim 9, wherein the volume percentage of the nanoplatelets of hexagonal boron nitride is in the range of 30-90%.

13. The coating of claim 9, wherein the acrylic binder is an acrylic binding resin.

14. The coating of claim 9, wherein the acrylic binder has a volume percent in the range of 10-70%.

15. The coating of claim 9, wherein the coating has a thickness in the range of 30-1500 micrometers.

16. The coating of claim 15, wherein the coating has a thickness in the range of 70-500 micrometers.

17. The coating of claim 9, wherein the coating has a total solar reflectance of at least 97% in the solar spectrum and a total sky window emissivity of 0.83 at a thickness of 150 micrometers.

18. The coating of claim 17, wherein the coating has a total solar reflectance of at least 90% and a total sky window emissivity of at least 0.7 at a thickness of 70 micrometers.

19. A method of manufacturing the composition for paint of claim 1 in the wet paint phase, the method comprising:
forming a first mixture by adding the nanoplatelets of hexagonal boron nitride to the solvent;
uniformly distributing the nanoplatelets in the first mixture; and
forming a second mixture by adding the acrylic binder to the first mixture.

20. The method of claim 19, wherein the step of uniformly distributing comprises sonicating the first mixture before forming the second mixture.

21. The method of claim 19, further comprising sonicating the second mixture to promote uniformity.

22. The method of claim 19, wherein at least one of forming the first mixture and forming the second mixture includes simultaneously stirring and heating the respective mixture.
